(19) United States
(12) Patent Application Publication
(10) Pub. No.: US 2004/0046706 A1
(43) Pub. Date: Mar. 11, 2004

(54) Method and apparatus for high-definition multi-screen display

(76) Inventors: In-Keon Lim, Seoul (KR); Chul-Jin Jang, Seoul (KR); Jun-Seok Park, Seoul (KR)

Correspondence Address: Volentine Francos, Suite 150, 12200 Sunrise Valley Drive, Reston, VA, 20191, US

(21) Appl. No.: 10/344,479

(22) PCT Filed: Jun. 14, 2002
(86) PCT No.: PCT/KR02/01117

(51) Int. Cl. G09G 5/00; G09G 5/02

(52) U.S. Cl. 345/1.1; 345/698

(57) ABSTRACT

The present invention discloses a multi-screen technique to display multi-channel images captured and transmitted from a multiple of cameras on a single monitor without the loss of resolution for each picture even if a multiple of images are displayed simultaneously.

### FIELD OF THE INVENTION

The present invention relates to a display dividing technique for multi-screen pictures on monitor, and more particularly to a video signal processing technique for multi-screen pictures on high-definition displaying means such as a computer monitor wherein each picture corresponds to each channel broadcasted from one of a plurality of video cameras.

### DESCRIPTION OF THE RELATED ART

Recently, a digital video recorder, which compresses, stores, and reproduces the captured image taken from image-capturing devices like video cameras and CCD cameras, is widely used for the security and surveillance system including a bank, a shop, and a home security system.

In an effort to enhance the monitoring capability of the security and surveillance. system employing the digital video recorders (DVRs), the DVR system usually includes a multiple of cameras that broadcast a variety of images captured at different locations through a plurality of channels.

In order to display a multiple of moving pictures captured by a plurality of cameras simultaneously on a single monitor, it is necessary to divide the full screen and assign each section of the full screen to a specific channel corresponding to each image-capturing camera.

In other words, the full screen of a single monitor should be divided by an appropriate number such as by four (Quad) or by sixteen, thereby implementing a multi-screen display.

FIG. 1 is a schematic diagram illustrating a multi-screen display for multiple channels on monitor in accordance with the prior art.

Referring to FIG. 1, each camera 90 captures images while the decoder 101 converts the captured analog video signals into the digital video signals.

In this case, the decoder 101 performs the conversion in accordance with the ITU-R format and stores the conversion data at FIFO (first-in first-out) 102.

For instance, the digital video signal from each video camera is stored temporarily at each FIFO 102 that is assigned to each channel for the synchronization of each image constituting the multi-screen.

Thereafter, the multi-screen is implemented by sequentially accessing a first FIFO, a second FIFO, • • •, and an n-th FIFO 102 for the scan under the control of an EPLD (erasable programmable logic device; 104).

For instance, in case when a 640×480 monitor is divided into a four-piece multi-screen (Quad), each section forming the multi-screen 106, 107, 108, 109 should have a resolution of 320×240

In order to scan the first line of a first picture 106 forming the multi-screen, the corresponding digital video data should be accessed at a first FIFO, followed by a process of accessing at a second FIFO for a second picture.

The digital video data that is accessed synchronously at a series of FIFOs 102 is processed by a digital signal processor and D/A converter, which are furnished in an encoder 103 to produce an analog signal for driving the monitor 105.

The screen-dividing technique according to the prior art, however, has a shortcoming since it results in the inevitable deterioration of the resolution since the resolution for multi-screen becomes poor (for instance, 320×480 for quad and 160×120 for 16-piece multi-screen.

Consequently, it becomes difficult or impossible to recognize the identity of the suspect, for example, recorded in the DVR system if the captured image is stored on the multi-screen DVR system such as a quad multi-screen (320×240) or a 16-piece multi-screen (160×120).

### SUMMARY OF THE INVENTION

It is an object of the present invention to provide a method and apparatus of processing the digital video data from a plurality of cameras for multi-screen pictures with the same maximum resolution as the case of the full screen for single channel.

It is another object of the present invention to provide a method and apparatus of processing the digital video data from a plurality of cameras for multi-screen pictures with the SD resolution (640×480 @30 i) both for the VCR (video cassette recorder) recording and/or the television display and for the SXGA interlaced display of 1280×1024.

Yet it is further an object of the present invention to provide a method and apparatus of processing the digital video data from a plurality of cameras for multi-screen pictures wherein the final resolution of each picture forming the multi-screen should be the specification as shown in the following table.

TABLE 1
Resolution of each picture forming the multi-screen
in accordance with the present invention

| | | Resolution for |
|---|---|---|
| Number of | Resolution for | each vertical |
| picture | each channel | synchronization |
| One | 720 × 480 | 720 × 240 |
| Four | 640 × 480 | 640 × 240 |
| Nine | 426 × 320 | 426 × 160 |
| Sixteen | 320 × 240 | 320 × 120 |

According to the one characteristic of the invention, the screen of a computer monitor with a resolution of 1280×1024 is divided by four pictures as the followings.

In other words, the analog image for each channel is decoded with resolution of 640×480 and stored at a first storing means with a clock rate of a first frequency.

Thereafter, the digital video data stored at a first storing means is stored at a clock rate of a second frequency that is higher than said first frequency.

Now, the digital video data of 1280×960 is accessed with a clock rate of a third frequency that is even higher than said second frequency under the control of the synchronization signal from said four second storing means corresponding to 4 channels and is scaled to 1280×1024.

Finally, the 1280×1024 digital video signal is now converted to an analog signal for the generation of RGB signals. As a consequence, the present invention makes it possible to fully utilize the resolution of the non-interlaced computer monitor for high definition even when the multi-screen picture scheme is used.

### BRIEF DESCRIPTION OF THE DRAWINGS

The above objects and advantages of the present invention will become more apparent by describing in detail a preferred embodiment thereof with reference to the attached drawings in which:

FIG. 1 is a schematic diagram illustrating the screen-dividing scheme in accordance with the prior art.

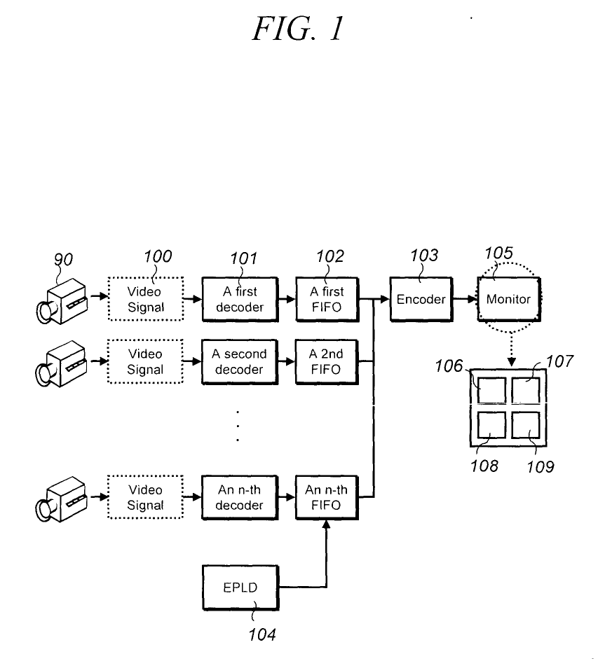

FIG. 2 is a schematic diagram illustrating a preferred embodiment of the presenting invention wherein each picture of the multi-screen pictures has the resolution of 640×480.

FIG. 3 is a schematic diagram illustrating the constitution of the driving circuit of the multi-screen system in accordance with the present invention.

### DETAILED DESCRIPTION OF THE PREFERRED EMBODIMENT OF THE INVENTION

The embodiment of the present invention is described below with respect to the attached drawings.

A feature of the present invention is that the captured image from each of the multiple of cameras is displayed without the deterioration of the resolution even for the multi-screen display.

For instance, the resolution of a captured image of a multi-screen picture for quad is downgraded to 320×240 in accordance with the prior art. On the contrary, the present invents makes it possible to maintain the resolution 640×480 in spite that the multi-screen (quad) scheme is adopted for four image-capturing cameras.

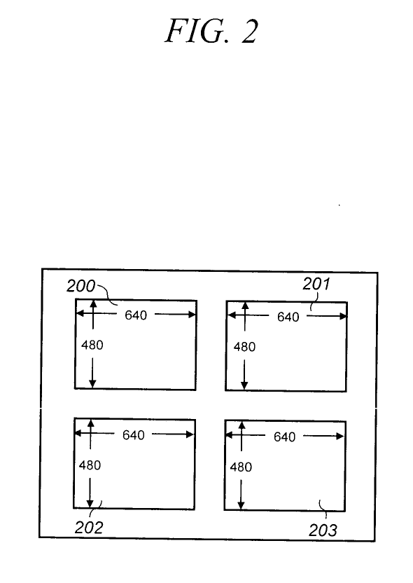

FIG. 2 is a schematic diagram illustrating an embodiment wherein each picture has a resolution of 640×480 for the multi-screen display. Referring to FIG. 2, each picture 200, 201, 202, 203 constituting the multi-screen (quad) has a resolution of 640×480, and therefore the multi-screen provides 1280×960 resolution.

As a consequence, the digital video data should be accessed at FIFO with a clock rate of 1280×960 @30 Hz=36,864,000 BPS (bit per second). As a preferred embodiment in accordance with the present invention, the data can be accessed at FIFO with an amount of 16 bits @40 MHz.

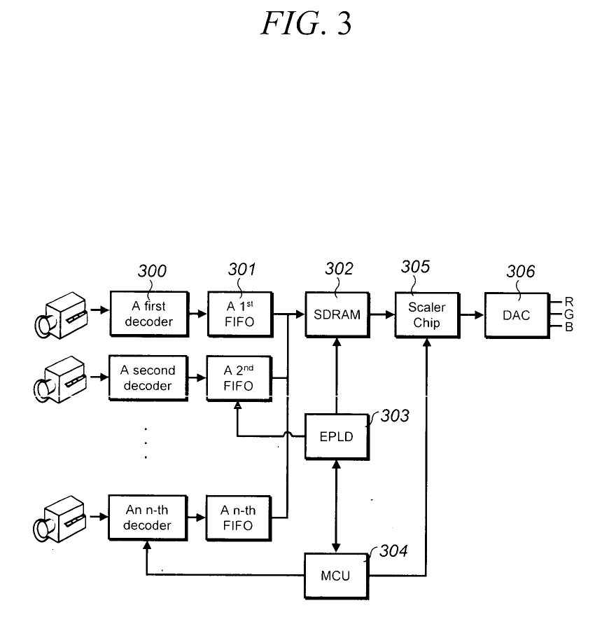

FIG. 3 is a schematic diagram illustrating the driving circuit for the multi-channel multi-screen display in accordance with the present invention.

Referring to FIG. 3, a video decoder 300 converts the analog image signal into the digital signal for each channel from a video camera, which is then stored at FIFO 301.

Preferably, the decoder 300 writes the video data in FIFO 301 at a rate of 135 MHz with a data size of 16 bits. Each input FIFO 30 is controlled either by an external synchronizing signal or by a synchronizing signal generated at an internal generator 310 and outputs the image data YUV of 16 bits. The image data has a format of the interlaced signals of 1280×960 @60 Hz.

As a preferred embodiment in accordance with the present invention, the aforementioned YUV digital video data of 16 bits can be output either via SD-grade terminal for VCR recording and television or via high-definition displaying terminal.

More preferably, the interlaced image data of 1280×960 @60 Hz can be converted into the one of 640×480 @60 Hz and stored at FIFO for the SD-grade display. Further, the converted data can be accessed either for the video encoder or for the VIP port via a controlled timing signal.

In this case, the video encoder converts the digital video data into analog video data. As another embodiment in accordance with the present invention, the video data can be accessed at a faster rate, for instance 1280×1960 @60 Hz interlaced 108 MHz or 1280×960 @30 Hz interlaced 54 MHz), and stored at SDRAM 302.

As a preferred embodiment in accordance with the present invention, a memory with fast accessing rate such as SGRAM can be employed. The video data YUV 4:2:2 is now converted to YUV 4:4:4 and the color space converter produces the RGB data with size of 24-bit.

As another embodiment in accordance with the present invention, the color space converter can be either a digital type or an analog type. Preferably, the read/write process at SDRAM can be performed with a crossed manner in order to reduce the number of memory.

The YUV data can also be employed in order to reduce the number of bits at I/O. Referring to FIG. 3 again, the scaler chip 305 performs the scaling either of 1280×960 @60 Hz interlaced 108 or of 1280×960 @30 Hz non-interlaced 54 Hz into 1280×1024 and converts the frame rate with reference to the synchronization signal. Moreover, the scaler chip 305 mixes the on-screen display (OSD) and outputs RGB of 24 bits.

The video data is converted to analog forms through the DAC 306. For the high-definition monitor, YUV or TMDS can be applied instead of RGB signals.

In the above, the detailed description has been given with respect the quad. However, the present invention can be applied and extended to 9-piece multi-screen and 16-piece multi-screen, etc. Furthermore, the broadcasting system can also be switched from NTSC and PAL system.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

### INDUSTRIAL APPLICABILITY

The present invention can be applied to a digital video recorder for security and surveillance system because it makes it possible to enhance the resolution of the captured image by more than four times even for the quad multi-screen system.

Furthermore, since the present invention provides an output of the SD grade (640×480 @30 i), it is also possible to be utilized for VCR recording and television display.

Since the present invention allows the DVR system to include only one (instead of four) quad chip for 16-channel DVR system, it is very economical.

What is claimed is:

1. A method of displaying images of four channels on a monitor with a resolution of 1280×1024 by dividing the screen into four pictures of equal size, comprising steps of:
decoding each analog image corresponding to a specific channel into a digital video data with a resolution of 640×480, followed by a process of storing the decoded data at a first storing means with a clock rate of a first frequency;
storing the decoded digital video data at a second storing means with a clock rate of a second frequency that is higher than said first frequency by accessing said first storing means;
accessing the digital video data of 1280×960 at four of second storing means with a clock rate of a third frequency that is even higher than said second frequency under the control of a synchronization signal, followed by a process of scaling the accessed data to a data of 1280×1024; and
generating the RGB signal by converting the 1280×1024 data to an analog signal.

2. The method as set forth in claim 1 wherein said first frequency is 13.5M MHz, said second frequency being 40 MHz, said third frequency being 54 MHz.

3. A method of displaying images of 9 channels on a monitor with a resolution of 1280×1024 by dividing the screen into 9 pictures of equal size, comprising steps of:
decoding each analog image corresponding to a specific channel into a digital video data with a resolution of 320×240, followed by a process of storing the decoded data at a first storing means with a clock rate of a first frequency;
storing the decoded digital video data at a second storing means with a clock rate of a second frequency that is higher than said first frequency by accessing said first storing means;
accessing the digital video data of 1280×960 at nine of second storing means with a clock rate of a third frequency that is even higher than said second frequency under the control of a synchronization signal, followed by a process of scaling the accessed data into the data of 1280×1024; and
generating the RGB signal by converting the 1280×1024 data into the analog signal.

4. The method as set forth in claim 3 wherein said first frequency is 13.5 MHz, said second frequency being 40 MHz, and said third frequency being 108 MHz.

5. A method of displaying images of sixteen channels on a monitor with a resolution of 1280×1024 by dividing the screen into sixteen pictures of equal size, comprising steps of:
decoding each analog image corresponding to a specific channel into a digital video data with a resolution of 320×240, followed by a process of storing the decoded data at a first storing means with a clock rate of a first frequency;
storing the decoded digital video data at a second storing means with a clock rate of a second frequency that is higher than said first frequency by accessing said first storing means;
accessing the digital video data of 1280×960 at four of second storing means with a clock rate of a third frequency that is even higher than said second frequency under the control of a synchronization signal, followed by a process of scaling the accessed data into the data of 1280×1024; and
generating the RGB signal by converting the 1280×1024 data into the analog signal.

6. The method as set forth in claim 5 wherein said first frequency is 13.5 MHz, said second frequency being 40 MHz, and said third frequency being 184 MHz.

7. The method as set forth in claims 1, 3, and 5 wherein said first storing means comprises a FIFO.

8 The method as set forth in claims 1, 3, and 5 herein said second storing means comprise SDRAM and SGRAM.

9. An apparatus of displaying images of m channels (m=n×n, n is an integer) from a multiple (m) of cameras on a monitor with a resolution of 1280×1024 by dividing the screen into m pictures of equal size, comprising:
a multiple (m) of decoding means for decoding each analog image corresponding to a specific channel into a digital video data with a resolutions of 720×480 for a single picture (n=1), 640×480 for quad multi-screen pictures (n=2), 426.66×320 for 9 multi-screen pictures (n=3), 320×240 for 16 multi-screen pictures (n=4), and so long;
a multiple (m) of a first storing means that store the decoded data of each channel with a clock rate of a first frequency;
a second storing means that stores the sequentially converted data with 16-bit YUV format at a clock rate of a second frequency that is higher than said first frequency from the m-channel data accessed at said first storing means;
a scaling means that converts the video data of 1280×960 accessed at said second storing means at a clock rate of a third frequency that is higher than said second frequency under the synchronization signal into a video data of 1280×1024; and
a D/A converter that converts the digital video data with resolution of 1028×1024 to an analog RGB data.

10. An apparatus of displaying images of m channels (m=n×n, n is an integer) from a multiple (m) of cameras on a monitor with a resolution of p×q by dividing the screen into m pictures of equal size, comprising:
a multiple (m) of decoding means for decoding each analog image corresponding to a specific channel into a digital video data with a resolutions of (p/n)×(q/n) for a single picture (n=1), 640×480 for quad multi-screen pictures (n=2), 426.66×320 for 9 multi-screen pictures (n=3), 320×240 for 16 multi-screen pictures (n=4), and so long;
a multiple (m) of a first storing means that store the decoded data of each channel with a clock rate of a first frequency;
a second storing means that stores the sequentially converted data with 16-bit YUV format at a clock rate of a second frequency that is higher than said first frequency from the m-channel data accessed at said first storing means;
a scaling means that converts the video data of accessed at said second storing means at a clock rate of a third frequency that is higher than said second frequency under the synchronization signal into a video data of p×q; and
a D/A converter that converts the digital video data of p×q into an analog RGB data.

11. The apparatus as set forth in claims 9 and 10 wherein said first storing means comprise a₁ FIFO.

12. The apparatus as set forth in claims 9 and 10 wherein said second storing means comprise AM and SGRAM.

13. The apparatus as wet forth in claims 9 and 10 wherein said third frequency is m times higher than said first frequency.
